(19) United States
(12) Patent Application Publication
(10) Pub. No.: US 2008/0023310 A1
(43) Pub. Date: Jan. 31, 2008

(54) Single-Hand Operated and Held Electronic Instrument

(75) Inventors: Seng Chuen Chong, Penang (MY); Soo Keat Lim, Penang (MY); Carol Geok Chooi Leh, Penang (MY)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 11/460,999

(22) Filed: Jul. 31, 2006

(51) Int. Cl. H01H 19/14

(52) U.S. Cl. 200/336

(57) ABSTRACT

An electronic instrument includes a rotary switch disposed to be rotated by the thumb of a user while the housing is gripped in the hand of the user. The rotary switch has a knob protruding from the front face of the instrument with a rotational axis centered approximately midway between longitudinal side walls of the housing. The rotary switch has a light rotational tension requiring a force of less than 300 grams for easy rotation by the thumb. Elastomeric over-molded side strips are attached along the longitudinal side walls and an elastomeric over-molded knob is attached along an indicator projection portion of the knob.

### FIELD OF THE INVENTION

The invention relates generally to the control of electronic instruments and more particularly to the single-handed control of handheld electronic instruments using a rotary switch.

### BACKGROUND OF THE INVENTION

U.S. Pat. No. 5,218,290 to Beckert et al. ('290) describes a multi-function, multi-mode switch for a digital multimeter (“DMM”). The DMM includes a rotary switch which can be rotated by the thumb of the same hand that is holding the electronic instrument. Thus, a user can hold and adjust the DMM with one hand while holding a probe of the DMM with the other hand. The single-handed holding and adjusting of the DMM is facilitated by placing the rotary switch so that it protrudes beyond the left side of the DMM. However, the offset position of the rotary switch limits the single-handed holding and adjusting of the DMM to the left hand. Alternatively, if the rotary switch is placed so that it protrudes beyond the right side of the DMM, then the single-handed holding and adjusting of the DMM is limited to the right hand. Thus, the single-handed holding and adjusting functionality of the prior art is limited to either the left or right hand for a given DMM.

This can be a problem because a user's left or right hand can become fatigued from holding the DMM for long periods of time and the user might want to switch hands. Also, at times it is more convenient to have one or the other hand hold the probe of the DMM depending on which side of the user the object to be measured is located. Due to the offset position of the rotary switch, a left-handed person might not be comfortable using the same DMM that a right-handed person is comfortable using.

Another problem with the DMM of the '290 reference is that it can be difficult to grip the DMM with a single hand while at the same time adjusting the rotary switch with the thumb. While taking measurements the user's hand can become moist. The DMM might then slip from the user's hand, fall to the ground or other hard surface, and break.

The designs of the rotary switches used with '290 and other prior-art handheld electronic instruments can also make it difficult to rotate the switches with the thumb. The spring tension of the rotary switches can be too tight and the dial of the rotary switch can be slippery, especially when the user's hand is moist as described above. Thus, these prior-art handheld electronic instruments usually are held in one hand while the rotary switch is turned with the other hand, thus requiring two hand operation. This is inconvenient for the user and can cause the user to lose focus on their work.

It would be desirable to provide an electronic instrument that can be securely held in either hand while at the same time allowing convenient rotation of a rotary switch of the electronic instrument with the thumb of the hand in which it is being held.

### SUMMARY OF THE INVENTION

The present invention provides an electronic instrument that can be securely held in either hand. At the same time it allows convenient rotation of a rotary switch of the electronic instrument with the thumb of the hand in which it is being held.

In general terms, one embodiment of the invention is a single-hand operated and supported electronic instrument. A more specific embodiment of the invention is an electronic instrument which includes a rotary switch disposed to be rotated by the thumb of a user while the housing is gripped in the hand of the user. The rotary switch has a knob protruding from the front face of the instrument with a rotational axis centered approximately midway between longitudinal side walls of the housing. The rotary switch has a rotational tension of between 218 and 340 gram-force (gf) for easy rotation by the thumb. Elastomeric over-molded side strips are attached along the longitudinal side walls and an elastomeric over-molded section is attached along an indicator projection portion of the knob.

### BRIEF DESCRIPTION OF THE DRAWINGS

Further preferred features of the invention will now be described for the sake of example only with reference to the following figures, in which:

FIG. 1 is a top, right side perspective view of a hand-held electronic instrument of the present invention.

FIG. 2 is a back plan view of the hand-held electronic instrument of FIG. 1.

FIG. 3 is a cutaway cross-sectional view of the housing of the hand-held electronic instrument of FIG. 1.

FIG. 4 is a blown-up view of a tongue and groove section of the housing of FIG. 3 after the side strips have been over-molded onto the housing recesses.

FIG. 5 is a top perspective view of a knob of a rotary switch.

FIG. 6A is a top plan view of the knob of the rotary switch.

FIG. 6B is a side cross-sectional view of the rotary switch taken along the line 6B-6B of FIG. 6A showing an axle and the knob of the rotary switch.

FIG. 7 is a blown-up view of the section 700 of the knob portion of FIG. 6B after the elastomeric over-molded covering has been over-molded to the plastic knob base.

FIG. 8 is a cutaway cross-sectional side view of the rotary switch taken along the line 8-8 of FIG. 6A.

FIGS. 9A-9D show the holding of the instrument 100 in the right hand of a user and the rotation of the rotary switch 109 using the right thumb of the user.

### DETAILED DESCRIPTION

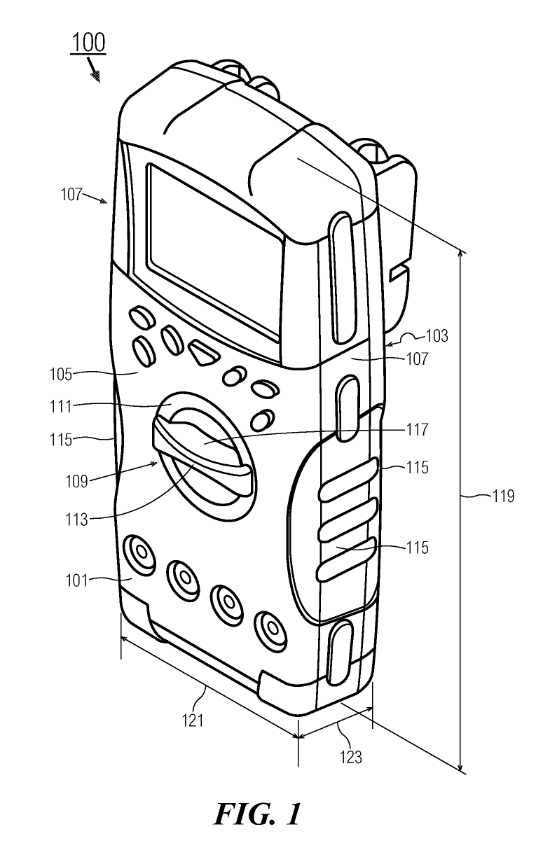

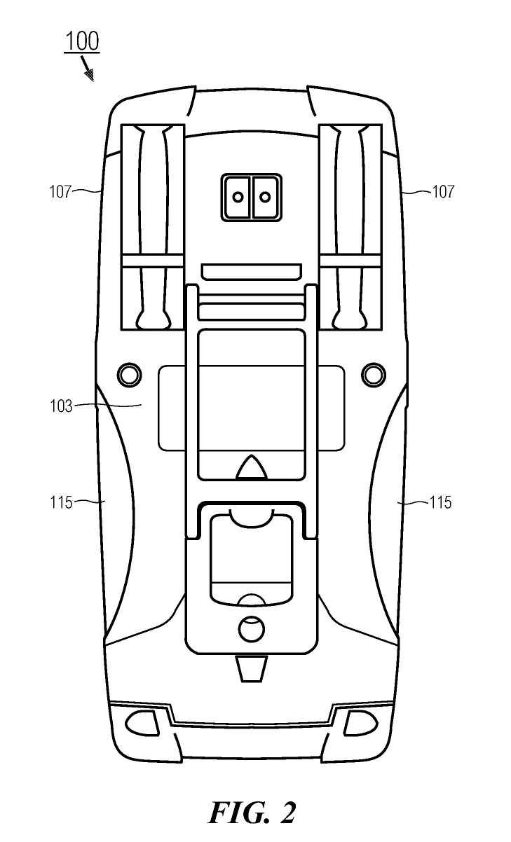

FIGS. 1 and 2 illustrate a hand-held electronic instrument 100 which, for example, can be a hand-held digital multimeter. The instrument 100 comprises a housing 101 having a back 103, a front face 105, and longitudinal side walls 107. FIG. 1 also shows a rotary switch 109 having a knob 111 protruding from the front face 105 of the housing 101.

The hand-held electronic instrument 100 is optimally designed to be held in either hand and provide for easy rotation of the rotary switch 109 with the thumb of the hand in which it is being held. A combination of several features contributes to this optimal design:

a) The size of the housing 101 is such as to allow a user to hold the instrument 100 in one hand while rotating the rotary switch 109 with the thumb of the hand in which it is being held.

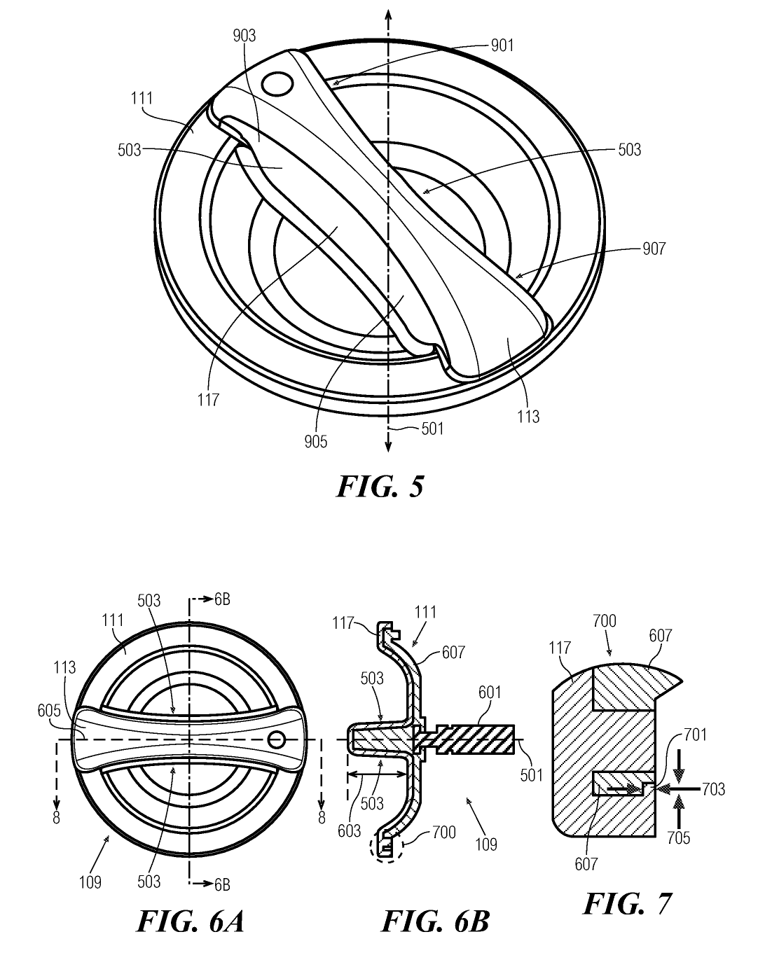

b) A rotational axis 501 (see FIG. 5) is centered approximately midway between the longitudinal side walls 107 along the front face 105 so that the rotary switch is symmetrical, thus allowing both left and right single handed holding and operation.

c) Elastomeric over-molded side strips 115 are over-molded along the longitudinal side walls 107 to allow secure gripping of the instrument 100 by either hand of the user.

d) The rotary switch 109 includes a indicator projection portion 113 having wide side faces 503 (see FIG. 5) so as to provide the thumb with a good surface area and leverage for rotating the rotary switch 109.

e) An elastomeric over-molded covering 117 is over-molded onto the side faces 503 of the indicator projection portion 113 to provide better contact and leverage between the thumb and side faces 503 to allow easier rotation of the rotary switch 109 using the thumb.

f) The tension of the rotary switch 109 is light enough so that it can be rotated by the thumb of the user pressing against the side faces 503 of the indicator projection portion 113 with a force of less of than three hundred and fifty grams and preferably less than three hundred grams.

Referring again to FIGS. 1 and 2, the elastomeric over-molded side strips 115 are over-molded along the longitudinal side walls 107 to allow secure gripping of the instrument 100 by either hand of the user.

The side strips 115 can be made from an elastomeric material having a hardness approximating that of human skin. In one embodiment the material is a soft rubber having a hardness matched to Shore 60A which is widely accepted as the typical hardness of human skin.

The side strips 115 are meant to comfortably and securely fit against the fleshy part of the hand of the user between the thumb and fingers when the instrument 100 is held by the user. In this position, the thumb of the user can reach the wide side faces 503 of the indicator projection portion 113 to rotate the rotary switch 109.

In prior-art hand-held instruments, a plastic housing is molded in a first mold and then the plastic housing is transferred to a second mold where rubber is over-molded to improve gripping of the instrument. However, a problem with this type of prior-art instrument is that the rubber is not only over-molded onto areas of the plastic housing where it is needed, but is over-molded to cover most of the instrument, including areas where the rubber over-molding is not necessary. Thus, material is wasted, resulting in higher material costs. Additionally, over-molding rubber over large sections of the instruments requires complicated and expensive mold construction.

The present invention positions the rubber sections only at locations of the housing 101 useful for gripping or protection from impacts, thereby reducing material costs and the complexity of second mold. This also reduces the molding time and thus improves the cycle time of the piece parts.

However, over-molding the rubber to cover most of the instrument provides the advantage of providing a more secure attachment between the rubber and the underlying plastic housing. When, as in the present invention, only relatively small, useful locations of the housing 101 are over-molded with the rubber, because of the softness of the rubber, the rubber can be prone to peeling.

To alleviate this problem, the present invention uses plastic base parts having gripping features that allow the rubber layer to hang tightly onto the plastic base parts. The rubber layers are also designed to wrap around the edges of parting lines and exposed edges to prevent the user from inadvertently peeling away the rubber layer with their fingers.

The present invention uses a two-shot cold molding technique to create the housing 101 with the over-molded rubber elastomeric side strips 115.

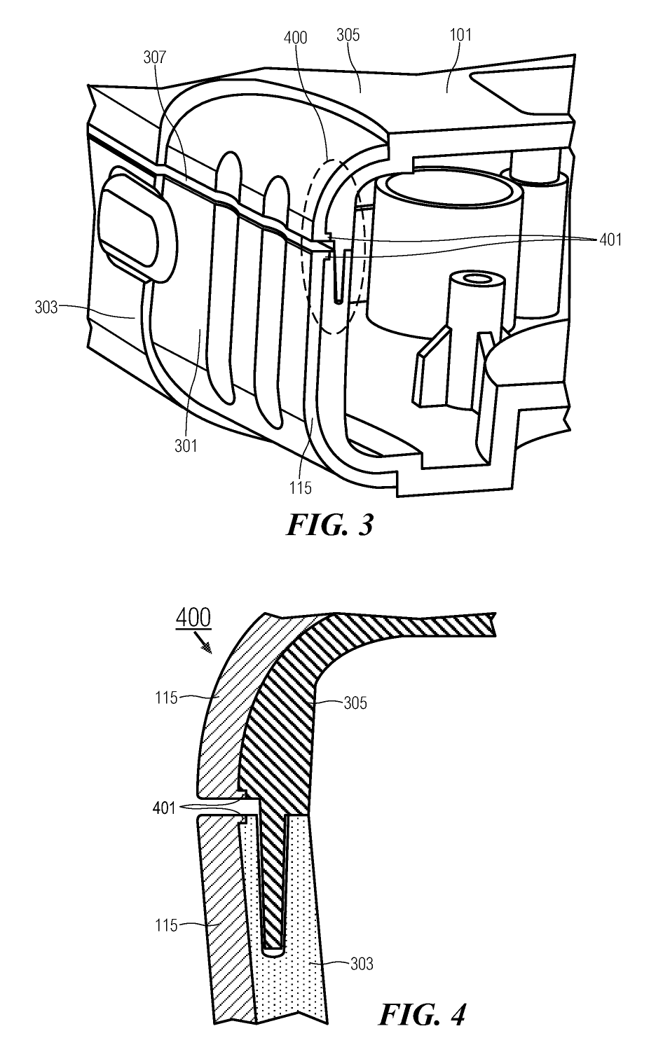

FIG. 3 is a cutaway cross-sectional view of a portion of the housing 101 of FIGS. 1 and 2. A front housing section 303 and a back housing section 305 are molded from plastic in first molds in a first cold molding shot. Formed in the sections 303, 305 are housing recesses 301 into which the rubber elastomeric side strips 115 are over-molded.

Sections 303, 305 fit together at a tongue and groove section 400. A parting line 307 is formed at the junction of the sections 303, 305. Grooves 401 are formed in each of the sections 303, 305 along a part of the parting line 307 within the housing recesses 301. In one embodiment these grooves 401 can be 0.27 to 0.33 millimeters deep.

The sections 303, 305 are each placed into second molds for the second shot of the two-shot cold molding process. In this step the rubber elastomeric side strips 115 are over-molded to the housing recesses 301 of the sections 303, 305. The over-molded plastic front and back housing sections 303, 305 can then be fit together at a tongue and groove section 400.

FIG. 4 is a blown-up view of a tongue and groove section of the housing of FIG. 3 after the side strips have been over-molded onto the housing recesses. The rubber of the side strips 115 grabs into these grooves 401. Thus the rubber eats into the plastic by 0.27 to 0.3 millimeters to increase it's grip onto the plastic housing 101.

In addition to the over-molded side strips 115 helping grip the instrument 100, the front face 105 can also roughened to provide an even more secure grip by a user.

FIGS. 5 and 6A show the knob 111 of the rotary switch 109, including the indicator projection portion 113 having the wide side faces 503, covered with the elastomeric over-molded covering 117, and the rotational axis 501. FIG. 6B is a cutaway cross-sectional side view of the rotary switch 109 taken along the line 6B-6B of FIG. 6A and shows the rotary switch 109 assembled from the knob 111 and an axle 601. The rotary switch 109 rotates about the rotational axis 501 passing through the center of the axle 601 and knob 111. As can be seen from examining FIG. 5 with reference to FIG. 1, the rotational axis 501 is centered approximately midway between the longitudinal side walls 107 along the front face 105.

Returning to FIG. 6B, the side faces 503 of the indicator projection portion 113 of the knob 111 have a side face height 603 of at least one-quarter of an inch. In other embodiments it is desirable to set the height 603 at between one half and one inch. In yet another embodiment the height 603 can be greater than three-quarters of an inch. The height 603 can also be approximately 0.43 inches as a compromise between a good surface for the thumb to press against while at the same time providing a convenient contour factor for the housing.

The height 603 can preferably be approximately the same or greater than the height of the end distal phalanx portion of the thumb of a user used to press against the side faces 503. This height 603 allows good leverage of the thumb against the side faces 503 to rotate the rotary switch 109. The indicator projection portion 113 runs generally along a diameter 605 of the knob and passes through the rotational axis 501 of the knob 111.

Also shown in FIG. 6B, the elastomeric over-molded covering 117 is over-molded onto the knob 111 and in particular covers the side faces 503 of the indicator projection portion 113 to provide better contact and leverage between the thumb and the side faces 503 to allow easier rotation of the rotary switch 109 using the thumb. Again, the over-molded covering 117 is made from an elastomeric material having a hardness approximating that of human skin is order to provide a more secure and comfortable contact with the thumb.

A plastic knob base 607 of the knob 111 is molded in a first mold in a first step of a two-shot cold molding process. In a second step of the two-shot cold molding process the plastic knob base 607 of the knob 111 is placed in a second mold for the second shot of the two-shot cold molding process. In this step the elastomeric over-molded covering 117 is over-molded to the plastic knob base 607.

FIG. 7 shows a close up detail view of the section 700 of the knob 111 of FIG. 6B with the elastomeric over-molded covering 117 over-molded to the plastic knob base 607. Grooves 701 are formed in the plastic knob base 607. In one embodiment these grooves 701 can be 0.27 to 0.33 millimeters deep and wide as shown by the dimensions 703 and 705, respectively, in FIG. 7. Preferably the dimensions 703 and 705 are 0.30 millimeters. The rubber of the elastomeric over-molded covering 117 grabs into these grooves 701. Thus, the rubber eats into the plastic by 0.27 to 0.33 millimeters to increase it's grip onto the plastic knob base 607.

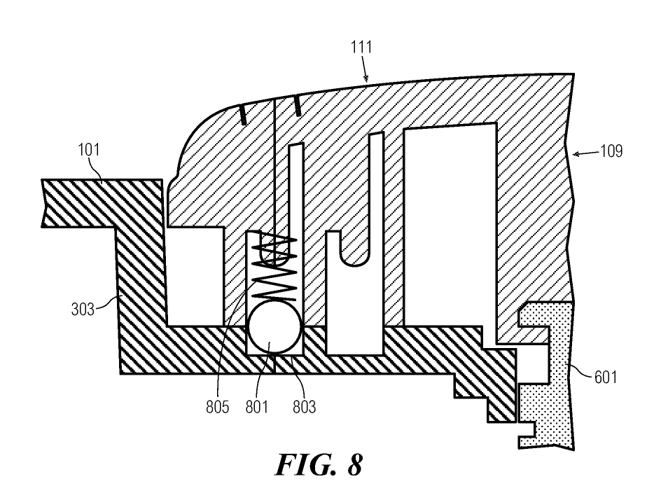

FIG. 8 is a cutaway cross-sectional side view of the rotary switch taken along the line 8-8 of FIG. 6A. A circular groove 803 has its center at the rotational axis 501. A bearing 801 rides in the circular groove 803 as the knob 111 is turned. The bearing can have a diameter of 3 millimeters and the groove 803 can have a width of slightly more than 3 millimeters, for example, to allow travel of the bearing 801 within the groove 803. The bearing 801 is biased against the groove 803 by a spring 805. The groove 803 can include peaks and valleys to allow the knob 111 to be stopped at pre-defined switch positions. The biasing of the bearing 801 by the spring 805 will settle the bearing into the pre-defined positions defined by the valleys in the groove 803. Such an arrangement is described in the prior art such as U.S. Pat. No. 4,876,416 to Frantz et al. issued on Oct. 24, 1989. Other rotary switch designs can be used as well.

In order to allow easy single thumb rotation of the rotary switch 109, the tension of the rotary switch 109 is light enough so that it can be rotated by the thumb of the user pressing against the side faces 503 of the indicator projection portion 113 with a force of less of than three hundred and fifty grams and preferably less than three hundred grams.

The force for turning the rotary switch 109 is determined by a combination of the spring 805 and compression of the spring 805. In one embodiment the spring 805 has a mean coil diameter of 2.70 millimeters, a pitch of 1.00 millimeters, a wire diameter of 0.30 millimeters, and a spring length of 5.00 millimeters when the spring is not compressed.

The following forces are required to compress the spring:

140 grams is required to compress the spring to a 4.0 millimeter length;

240 grams is required to compress the spring to a 3.5 millimeter length; and

350 grams is required to compress the spring to a 3.0 millimeter length.

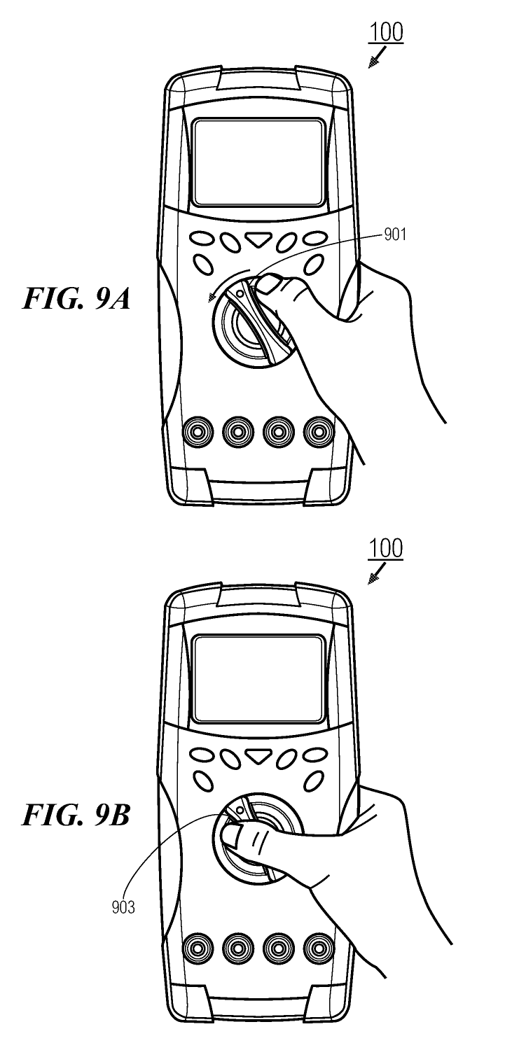

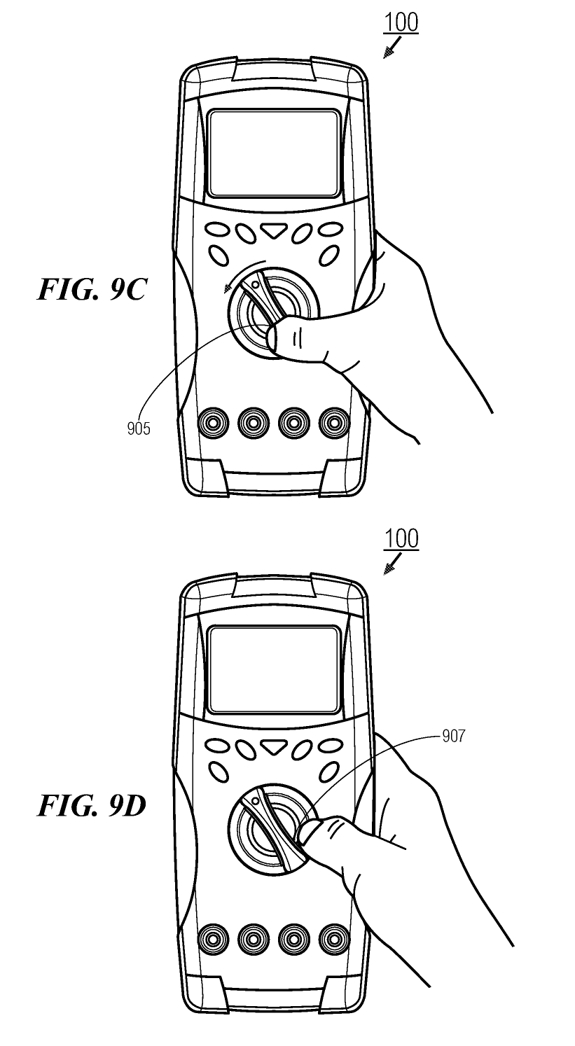

FIGS. 9A-9D show the holding of the instrument 100 in the right hand of a user and the rotation of the rotary switch 109 using the right thumb of the user.

The user grips the back 103 of the housing 101 with four fingers of the hand. The over-molded side strips 115 are griped with the right hand palm of the user. The side strips 115 are meant to comfortably and securely fit against the fleshy part of the hand of the user between the thumb and fingers. The front face 105 is gripped by the side portion of the right thumb of the hand of the user while simultaneously pressing on the elastomeric over-molded covering 117 of a side face 503 of the indicator projection portion 113 with the end distal phalanx portion of the thumb. The front face 105 can be roughened to provide an even more secure grip with the right thumb.

As illustrated in FIGS. 9A-D and FIG. 5, the right thumb can rotate the rotary switch 109 clockwise by pressing on the side face 503 of the indicator projection portion 113 at a position 903 (FIG. 9B) or a position 907 (FIG. 9D). The right thumb can rotate the rotary switch 109 counterclockwise by pressing on the side face 503 of the indicator projection portion 113 at a position 901 (FIG. 9A) or a position 905 (FIG. 9C).

Similarly, when the instrument 100 is held in the left hand of a user (not illustrated), the left thumb can rotate the rotary switch 109 clockwise by pressing on the side face 503 of the indicator projection portion 113 at the position 903 or the position 907. The left thumb can rotate the rotary switch 109 counterclockwise by pressing on the side face 503 of the indicator projection portion 113 at the position 901 or the position 905 (FIG. 5).

Referring again to FIG. 1, the instrument 100 can have a height 119 of approximately 8 inches, a width 121 of approximately 3½ inches and a depth 123 of approximately 1⅜ inches. This height 119 and width 121 allows the thumb to reach the indicator projection portion 113 positions 901, 903, 905, 907 while the instrument 100 is being held in the same hand with the side strips 115 securely pressing against the fleshy part of the hand of the user between the thumb and fingers. The height 119 and/or width 121 can also be smaller which can still allow comfortable holding and adjusting of the instrument 100, especially for users with smaller hands.

In the foregoing specification, the invention has been described with reference to specific exemplary embodiments thereof. The specification and drawings are, accordingly, to be regarded in an illustrative sense rather than a restrictive sense.

1. An electronic instrument comprising:
a housing having a back, a front face, and longitudinal side walls;
a rotary switch having a knob protruding from the front face of the housing, the rotary switch having a rotational axis centered approximately midway between the longitudinal side walls along the front face;
an indicator projection portion of the knob having side faces with a height of at least one-quarter inch, the indicator projection portion running generally along a diameter of the knob and passing through the rotational axis of the knob and; and
over-molded side strips over-molded along the longitudinal side walls and an over-molded covering over-molded onto the knob and covering side faces of the indicator projection, the over-molded side strips and the over-molded covering made from elastomeric material having a hardness approximating that of human skin; and
wherein the rotary switch is disposed to be rotated by the thumb of the hand of the user pressing against an over-molded covered face of the indicator projection with a force of less than three hundred and fifty grams while the housing is gripped in the hand of the user by:
gripping the back of the housing with four fingers of the hand of the user, gripping the over-molded side strips with a palm of the hand of the user, and gripping the front face with a side portion of a thumb of the hand of the user, while simultaneously pressing on the face of the indicator projection with an end distal phalanx portion of the thumb.

2. The electronic instrument of claim 1, wherein the housing is molded from plastic in a first shot of a two-shot cold molding process.

3. The electronic instrument of claim 2, wherein the over-molded side strips are over molded onto the longitudinal side walls of the housing in a second shot of the two-shot molding process.

4. The electronic instrument of claim 3, wherein the housing further comprises grooves and the elastomeric material of the over-molded side strips grabs into the grooves to secure the over-molded side strips to the housing.

5. The electronic instrument of claim 4, wherein the grooves are from 0.27 to 0.33 millimeters deep.

6. The electronic instrument of claim 1, wherein the knob is molded from plastic in a first shot of a two-shot cold molding process.

7. The electronic instrument of claim 6, wherein the over-molded covering is over molded onto the knob in a second shot of the two-shot molding process.

8. The electronic instrument of claim 7, wherein the knob further comprises grooves and the elastomeric material of the over-molded covering grabs into the grooves to secure the over-molded covering to the knob.

9. The electronic instrument of claim 8, wherein the grooves are from 0.27 to 0.33 millimeters deep.

10. The electronic instrument of claim 1, wherein the elastomeric material is rubber having a hardness approximately matched to Shore 60A.

11. The electronic instrument of claim 1, wherein the electronic instrument is a digital multimeter.

12. An electronic instrument comprising:
a housing having a back, a front face, and longitudinal side walls; and
a rotary switch having a knob protruding from the front face of the housing, the rotary switch having a rotational axis centered approximately midway between the longitudinal side walls along the front face and wherein the rotary switch is disposed to be rotated by a thumb of a hand of a user.

13. The electronic instrument of claim 12, further comprising:
an indicator projection portion of the knob having side faces with a height of at least one-quarter inch, the indicator projection portion running generally along a diameter of the knob and passing through the rotational axis of the knob.

14. The electronic instrument of claim 13, wherein the indicator projection portion has a height of at least three quarters of an inch.

15. The electronic instrument of claim 12, further comprising over-molded side strips over-molded along the longitudinal side walls and an over-molded covering over-molded onto the knob and covering side faces of the indicator projection, the over-molded side strips and the over-molded covering made from elastomeric material having a hardness approximating that of human skin.

16. The electronic instrument of claim 12, wherein the thumb of the user rotates the rotary switch by pressing against an over-molded covered face of the indicator projection with a force of less than three hundred and fifty grams while the housing is gripped in the hand of the user.

17. The electronic instrument of claim 16, wherein the user rotates the rotary switch by: gripping the back of the housing with four fingers of the hand of the user, gripping the over-molded side strips with a palm of the hand of the user, and gripping the front face with a side portion of a thumb of the hand of the user, while simultaneously pressing on the face of the indicator projection with an end distal phalanx portion of the thumb.

18. The electronic instrument of claim 15, wherein the housing further comprises grooves and the elastomeric material of the over-molded side strips grabs into the grooves to secure the over-molded side strips to the housing.

19. The electronic instrument of claim 15, wherein the knob further comprises grooves and the elastomeric material of the over-molded covering grabs into the grooves to secure the over-molded covering to the knob.

20. The electronic instrument of claim 18, wherein the grooves are from 0.27 to 0.33 millimeters deep.

21. The electronic instrument of claim 12, wherein the rotary switch is disposed to be rotated by the thumb of the hand of the user pressing against the over-molded covered face of the indicator projection with a force of less than three hundred grams while the housing is gripped in the hand of the user.
